(19) United States
(12) Patent Application Publication
(10) Pub. No.: US 2011/0307281 A1
(43) Pub. Date: Dec. 15, 2011

(54) MODEL INVENTORY MANAGER

(75) Inventors: RICHARD CREVELING, Ft. Collins, CO (US); TRENT MISKELLY, Houston, TX (US); SAMUEL A. SPROUSE, Houston, TX (US)

(73) Assignee: SATTERFIELD & PONTIKES CONSTRUCTION, INC.

(21) Appl. No.: 12/813,743

(22) Filed: Jun. 11, 2010

(51) Int. Cl. G06Q 10/00; G06F 17/30

(52) U.S. Cl. 705/7.11; 707/790; 707/E17.044

(57) ABSTRACT

A method and apparatus for managing a building model inventory, including a database structured for storing element specification and instance data from both a previous version and a latter revision of building information modeling datasets, respectively. In addition to the building information modeling element data, the database associates completed assembly pass, unit cost, work breakdown structure, and other inventory management data with the element type definitions and element instance data. Application software compares the first and second inventory revisions to identify all changes, additions and/or deletions of building elements between the previous version and the latter revision of the building information modeling datasets. By tracking the elements that change, the changes that affect the construction schedule and quantity, configuration and specification of materials are identified. An engineering cost analysis based on the changed data provides a rapid understanding of the implications of any design change.

### BACKGROUND OF THE INVENTION

1. Field of the Invention

This invention relates generally to the use of Building Information Modeling (“BIM”) systems, and in particular to a system and method that enhances the ability of a design team to manage (1) the design process, (2) the construction planning and scheduling, and (3) the resultant in-place construction cost for a structure.

2. Background Art

Building Information Modeling is an integrated computer-aided-design process based in three-dimensional object modeling of the design of a construction project, including not only buildings, but also bridges, dams, refineries, airports or any other construction project. BIM is being rapidly adopted by building design and construction industries, because among other uses, it allows a three-dimensional (“3D”) machine-readable design model to be created and used for design coordination, quantity surveying, construction planning, and ultimately, facilities management. Because BIM systems use computer files in standardized formats, BIM increases the speed, accuracy and coordination of information exchange between building owners, designers, construction contractors, and other design team members. One such BIM design software platform is the Autodesk Revit suite of applications for the design of the architectural, structural, mechanical, electrical, and plumbing systems of a building.

In a typical large-scale construction project, the project architect and design engineers produce drawings, specifications, and additional contract documents, which are supplied to a contractor and provide the information for cost estimating, logistical planning, and scheduling. From such documents, the contractor estimates the bill of materials and the cost of both labor and materials in addition to the cost of general requirements for operation of the project jobsite together with overhead costs and fees.

With the advent of BIM, using the computer files provided by the architecture and design team, the building contractor may now employ software specifically created to determine the quantities of materials, associated unit costs, labor costs, construction schedule and other requirements necessary to complete the specified building design and to more easily and rapidly create a complete and well-defined cost estimate. For example, VICO Software Constructor, RS Means SmartBIM QTO and Innovaya Visual Estimating are commercially available quantity survey and estimating software products. Timberline Software Corporation has also released estimating software that uses 3D design models in an IFC 2.0 file format, which was developed by the International Alliance for Interoperability for translation of 3D CAD files to provide a machine-readable capacity to interpret element dimensions during the estimating process.

Quantity surveys are commonly performed on the basis of assemblies, rather than individual building components. An “assembly” is a group of items that includes a set of costing rules and formulas that allows an estimator to more efficiently complete the cost estimate. Typically, an assembly includes related items that are required to complete a particular unit of work. The estimator is able to define the assemblies that are typical to the contractor's work and store them in a database for repeated use on multiple projects.

The most prevalent project delivery method in the building construction industry is termed “design, bid, build,” in which a contractor is selected to construct a building from a completed design. This delivery method tends to place the owner, designers, and contractors in non-collaborative, and sometimes adversarial relationships. However, a collaborative, value-added delivery method is also known in the art. In the value-added delivery method, the contractor provides assistance in the design process, lending its expertise in assessing and optimizing the project's constructability and resultant cost. The contractor prices the project at an early stage, before a building design has been completed, based on preliminary cost estimates produced from outline specifications and a preliminary building design concept. The contractor is selected well in advance of the completion of the design.

Using a collaborative delivery method, at the outset of a building project, anticipated costs are developed by the contractor based on assessments derived from outline specifications and interpretation of the generalized building design concepts. Throughout the design process, it is customary for a contractor to periodically receive updated revisions of the building plans for review, analysis, cost estimating, and providing collaborative feedback. Each revision advances the building design towards completion, and the contractor is therefore able to provide a more reliable estimate of construction costs from each subsequent issuance of project documentation.

Changes will occur in the quantity, configuration, specification, and market price of materials as the design progresses. Those changes will produce fluctuations in the estimated cost of the structure. As the foregoing changes occur, through collaborative feedback the contractor has a greater potential to positively influence the project completion of the design process. Accordingly, the contractor must be able to rapidly analyze and provide useful information to the collaborative design team on a timely basis.

Regardless of whether the design information is recorded in conventional two-dimensional paper drawings or BIM 3D CAD files, in a non-collaborative delivery scheme, it is not customary to highlight or explicitly identify what has been changed, added, or deleted as the design approaches completion. That is, the evolution of the design is not documented with explicit change notes. Only after design documentation has been issued as “for construction” are the revisions to the completed design tracked and identified explicitly. For these released drawings, a substantial amount of decision-making has already been completed, leaving little opportunity for the contractor to add value.

Even in a collaborative delivery method where design changes may be documented, the conventional way to identify such design changes in unreleased interim building design updates is by visual inspection of the design revisions, which is laborious and prone to incomplete recognition of all of the changes. Moreover, not all changes may be documented. One method to which contractors have resorted for identifying additions, deletions or changes to the content of the design is to superimpose previous and current building plans, printed on velum, one on top of the other over a light table. However, with scores to hundreds of prints, such method is too slow for providing the required rapid feedback necessary to add value to in a collaborative design process. Moreover, because the drawings are two dimensional representations of a three dimensional design, changes affecting the third dimension are easily obscured.

According to current practice, when the contractor receives revised building design documentation, the contractor generates updated quantity surveys and cost estimates. Because of the difficulty in identifying all of the changes, additions and deletions in the plans, each updated estimate is essentially a new estimate, started from scratch, which requires an increasing level of rework in estimating elements of the design that have not changed simply in order to capture those unidentified elements that have changed.

It is desirable, therefore, to have a system and method by which the contractor can rapidly identify all changes, additions, and deletions between two revisions of a design in a BIM system and provide a quantitative analysis of the effects that such changes, additions, and deletions have on the cost of construction and schedule.

3. Identification of Objects of the Invention

A primary object of the invention is to provide a method and apparatus by which a contractor or subcontractor can rapidly identify all changes, additions, and deletions between two revisions of a design in a BIM system and provide a quantitative analysis of the effects that such changes, additions, and deletions have on the cost of construction and schedule.

Another object of the invention is to provide a method and apparatus for managing a model inventory of building elements that associates unit costs with the individual building elements.

Another object of the invention is to provide a method and apparatus for managing a model inventory of building elements that allows a contractor to rapidly perform an engineering cost analysis to determine cost and schedule effects from a revision to a building design.

Another object of the invention is to provide a method and apparatus for managing a model inventory of building elements that is compatible with industry-accepted building information modeling systems.

Another object of the invention is to provide a method and apparatus for establishing a budget for a project concept in terms of scope of work.

Another object of the invention is to provide a method and apparatus for identifying constraints in the design of building systems so as to develop a sequence and schedule for project design tasks.

Another object of the invention is to provide a method and apparatus for recording a complete inventory of building elements and their properties that present in a given revision of a building design model.

Another object of the invention is to provide a method and apparatus for visual inspection of both individual building elements and collections of building elements, for example, in tabular fashion.

Another object of the invention is to provide a method and apparatus for appropriately assigning default attributes to building elements, for example, based on the element type.

Another object of the invention is to provide a method and apparatus for managing a model inventory of building elements that associates construction labor productivity rates with individual building elements.

Another object of the invention is to provide a method and apparatus for determining material specifications in the design that are new to the design, and for analyzing and defining properties for the new specifications independent of design model data.

Another object of the invention is to provide a method and apparatus for identifying not only changes in building element quantities between two iterations of a design model, but also changes in building element specifications and properties between two iterations of a design model.

Another object of the invention is to provide a method and apparatus for providing quantitative metrics of the cost and schedule performance of the ongoing design process relative to planned targets of progress and completion.

Another object of the invention is to provide a method and apparatus for reassessing and refining a design in response to deficiencies in design performance.

### SUMMARY OF THE INVENTION

The objects described above and other advantages and features of the invention are incorporated in a method and model inventory management (“MIM”) system for managing a building model inventory—i.e., for managing the raw materials, stock, and work-in-progress required for or associated with the progressing design of a particular construction project. The system includes a database with multiple record sets structured for storing building elements from both a previous version and a latter revision of building information modeling datasets, respectively. A unique identifier is added by the MIM system to the BIM data for distinguishing revision record sets from one another.

In a preferred embodiment, the database includes data that characterizes or defines an element type—i.e., the element specifications. Accordingly, in addition to the CAD element data, the record sets also include fields for storing completed assembly passes, unit costs, work breakdown structure, and other MIM properties for actively managing the building inventory. The database also stores data that tracks the quantity, or number of instances, of each element type for each revision.

The MIM system includes application software designed and arranged to compare revision record sets to identify all changes, additions and/or deletions of both building element specifications and element quantities between a previous version and a latter revision of the building information modeling datasets. By tracking the elements that change, the contractor is better equipped to understand the causes that result in changes to the construction schedule and quantity, configuration and specification of materials. Moreover, tracking the changes allows unit costs for the building elements to be derived and refined. According to a preferred method of the invention, the contractor, having established a model inventory management system with a building element inventory database, compares each new BIM design model received from the design team and performs an engineering cost analysis based on the changed data for obtaining a rapid understanding of the implications of any design change.

### BRIEF DESCRIPTION OF THE DRAWINGS

The invention is described in detail hereinafter on the basis of the embodiments represented in the accompanying figures, in which:

FIG. 1 is a block-level representation of a system according to a preferred embodiment of the invention for managing a model element inventory by a contractor, showing a model information system implemented on a central server computer that is in communication with an architect's building information modeling system;

FIG. 2 is a diagrammatic view of a simplified schema of a model inventory manager element database according to the preferred embodiment of the invention;

FIG. 3 is a flow chart diagram that illustrates a machine-enabled iterative design review and model inventory management process according to a preferred embodiment of the invention;

FIG. 4 is a flow chart diagram that illustrates a detailed process for performing a quantitative analysis step of the process of FIG. 3 according to a preferred embodiment of the invention;

FIG. 5 is a diagrammatic view of a schema of an assembly pass used by process of FIGS. 3 and 4; and

FIG. 6 is a more detailed and complete schema than that of FIG. 2 for the model inventory manager element database according to the preferred embodiment of the invention.

### DESCRIPTION OF THE PREFERRED EMBODIMENT OF THE INVENTION

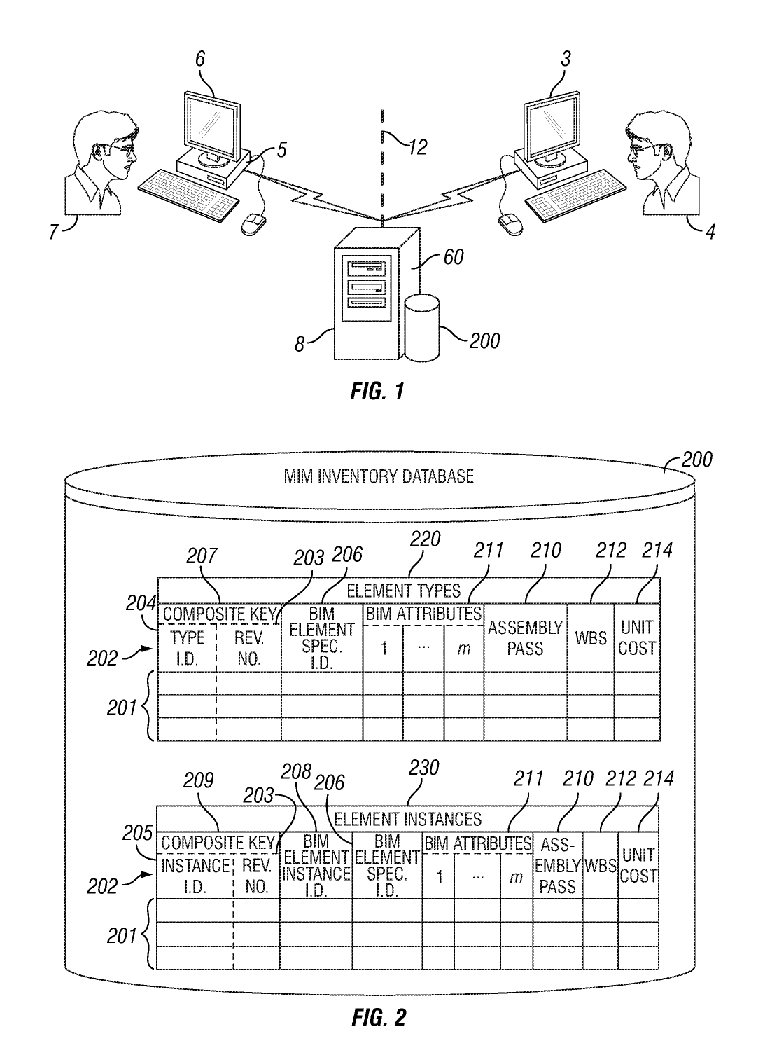

FIG. 1 illustrates a Model inventory management (“MIM”) system 60 according to a preferred embodiment of the invention. MIM system 60 ideally resides on a central server computer 8 that includes a database 200. MIM system 60 is in communication with a computer 3 that is operable by a contractor 4 or the like. MIM system 60 is also in communication with a building information modeling (“BIM”) system 5 for receiving therefrom computerized building plans and modeling files and for providing thereto feedback and updates. BIM system 5 typically resides on a computer 6 that is operable by an architect 7 or the like, but it may also reside on central server computer 8, if desired. Communications between MIM system 60 and other devices or systems may occur by routine pushing or pulling of data, as appropriate. Computers 3, 6, and server 8 are well known in the art. For this reason, they are not discussed in detail herein.

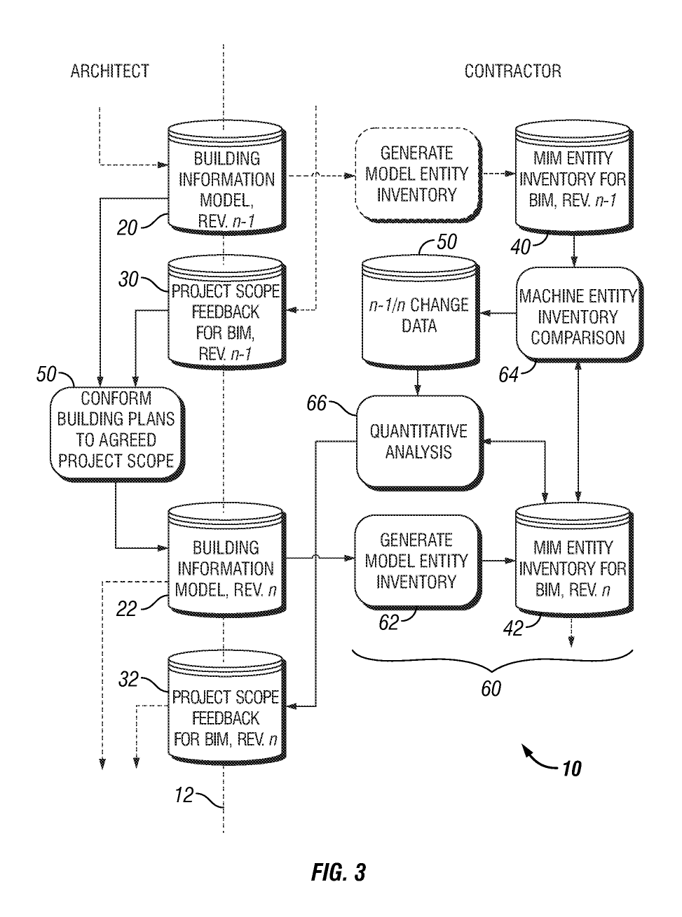

According to the preferred embodiment of the invention, the contractor employs a model inventory management system 60 that includes a database 200 of inventory elements. FIG. 2 illustrates database 200, which can be accessed by computer 3 (FIG. 1) as is known in the art.

MIM database 200 defines a number of fields 202 and includes records 201 arranged for storing building model elements. Two types of data are associated with building model elements—(1) element specifications, which define and characterize what physical object a particular element type represents, and (2) element instances, which are actual occurrences or calls for an element of a specific element type within a design. Database 200 stores both of these types of data. Database 200 preferably includes an Element Type table 220, for defining element types and their specifications, and a separate Element Instance table 230 for storing instances of elements. Although FIG. 2 illustrates a schema in which element specification and element instance data are included in separate tables, other arrangements, including a single table, more than two tables, or even multiple database systems, may be used within the scope of the invention.

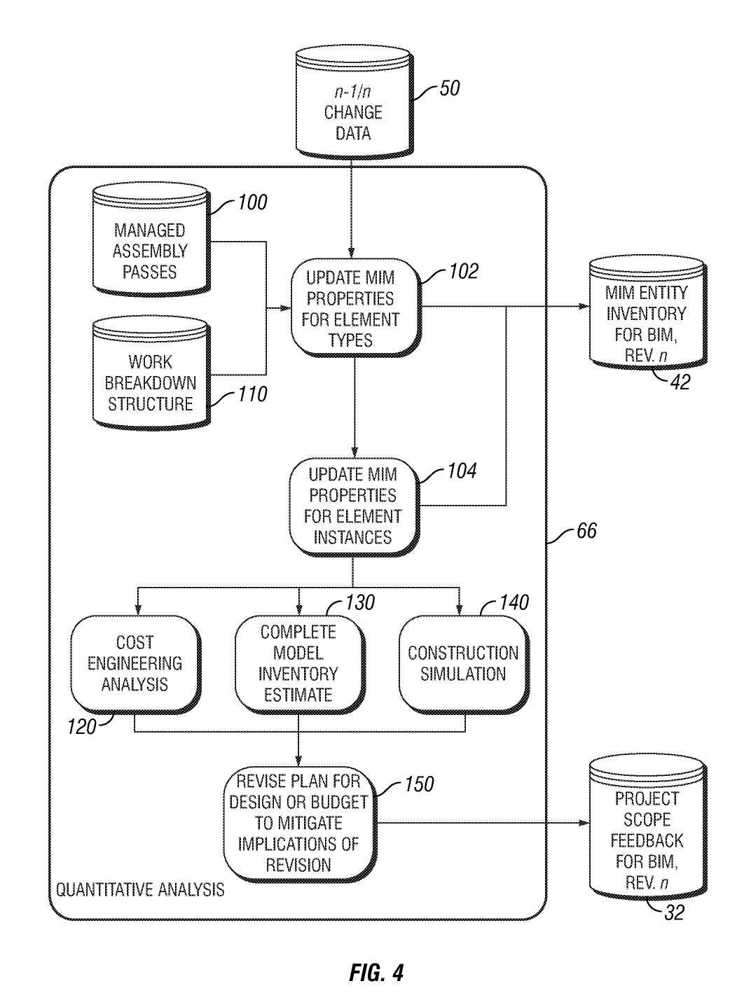

Referring to Element Type table 220, database 200 includes an Element Type I.D. field 207 that acts as a unique primary key for each element type. Element Type I.D. field 207 is assigned by MIM system 60. In a preferred embodiment of the invention, Element Type I.D. field 207 is a composite key, consisting of an entity type I.D. portion 204 and a model inventory I.D. portion 203. The entity type I.D. 204 remains the same from one inventory revision to the next, but the model inventory I.D. 203 uniquely reflects each inventory revision number so as to allow record sets 40, 42 (FIG. 3) to be created for each BIM revision, as described below. Although Element Type I.D. field 207 is described as a composite key consisting of a entity type I.D. 204 and a model inventory I.D. 203, separate fields could be used as is known in the art of database programming.

Element Type table 220 preferably includes a unique indicium from BIM system 5 (FIG. 1) that is associated with each MIM element type in BIM Element Specification I.D. field 206. Other attributes from BIM system 5 that define specifications for an element type are stored in fields 211. Additionally, as explained in greater detail below, an Assembly Pass field 210, a Work Breakdown Structure field 212, and a Unit Cost field 214 are element specification data that are assigned by MIM system 60.

Referring to Element Instance table 230, database 200 includes an Element Instance I.D. field 209 that acts as a unique primary key for each element instance. Element Instance I.D. field 209 is assigned by MIM system 60. Like Element Type Field 207, Element Instance I.D. field 209 is ideally a composite key, consisting of an entity instance I.D. portion 205, which remains constant from one inventory revision to the next, and the revision-identifying model inventory I.D. portion 203. Although Element Instance I.D. field 209 is described as a composite key consisting of a entity instance I.D. 205 and a model inventory I.D. 203, separate fields could be used if desired.

BIM system 5 provides a unique I.D. for each instance of an element and a code that designates what type of element each instance is. Such data is stored in database 200 under BIM Element Instance I.D. field 208 and BIM Element Specification I.D. field 206, respectively. Additionally, some of the BIM attributes, such as length, width, height, and position dimensions that may be specific to each instance of an element, are stored in fields 211.

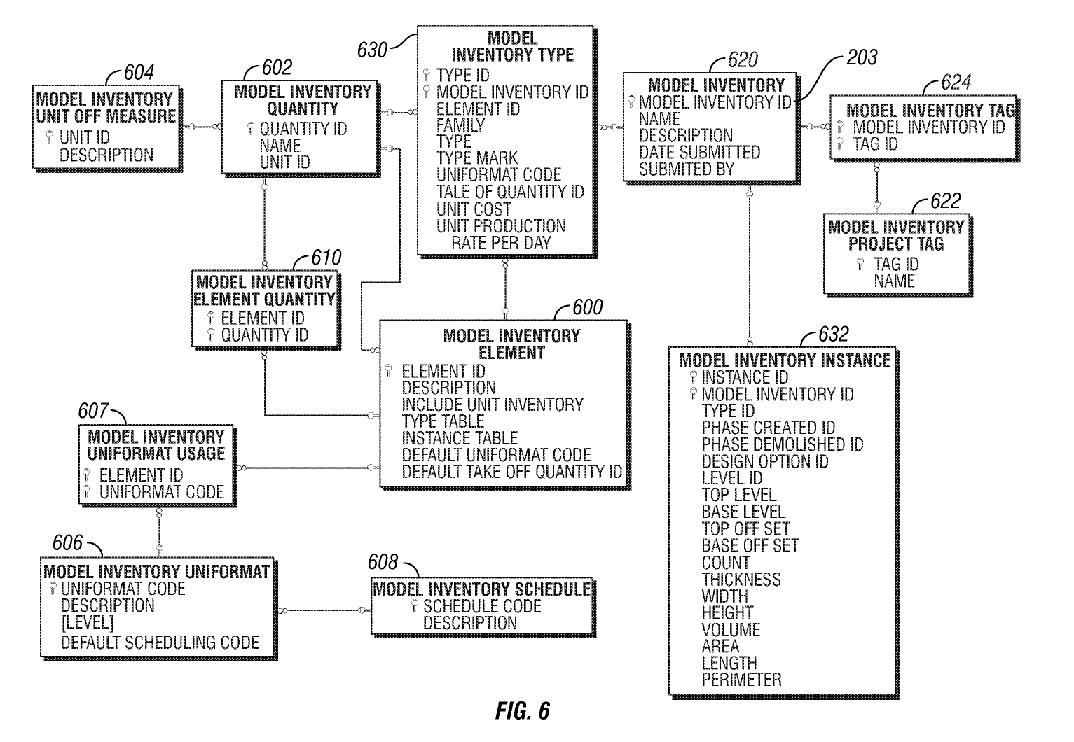

As described herein, BIM Element Specification I.D. field 206 is used to associate data between the Element Type table 220 and the Element Instance table 230. However, other ways to associate element instances with element types (one example of which is illustrated in FIG. 6 and described below) may be used as appropriate.

FIG. 3 is a flow chart diagram that describes a machine-enabled model inventory management process and design review cycle 10 between an architect and a contractor for a complex building project according to a preferred embodiment of the invention. To the left side of dashed line 12, the architect's steps are illustrated, and to the right side of a dashed demarcation line 12, the contractor's steps are illustrated. The building information modeling computer files 20, 22 for each revision in the design cycle are illustrated superimposed on top of dividing line 12 to indicate that the BIM files are provided by the architect to the contractor. Similarly, the contractor's feedback to the architect based on each new revision to the building model, referred to in FIG. 3 as the project scope feedback 30, 32, is illustrated superimposed on top of dividing line 12 to indicate that the feedback data are provided by the contractor to the architect. FIG. 3 is drawn such that it repeats upwardly for previous BIM versions and downwardly for future BIM revisions. Accordingly, the revisions are just generically annotated on FIG. 3 as a single previous revision (n−1) and a current revision (n).

As the architect continues the design process and develops more complete and detailed sets of plans, the architect's role in process 10, as depicted on the left side of FIG. 3, includes revising the plans to conform the building design to the scope of work agreed upon between the architect and contractor. That is, the architect incorporates the contractor's feedback in each new BIM revision. FIG. 3 illustrates the process: Taking as input the then current (version n−1) building information model 20 and the project scope feedback 30 (which is based on building information model 20), in step 50 the architect creates a new BIM revision 22 (version n). The new BIM files 22 are then provided to the contractor for evaluation.

According to the preferred embodiment of the invention, the contractor employs a model inventory management system 60 that includes a database 200 of inventory elements. MIM database 200 includes Revision Number indicia. 203 (FIG. 2) so as to define multiple inventory record sets to distinguish between BIM revisions. Accordingly, FIG. 3 shows a MIM element inventory record set 40 that corresponds to BIM version 20 (n−1) and a MIM inventory record set 42 that corresponds to BIM version 22 (n).

Each MIM inventory 40, 42 includes elements that are extracted directly from the corresponding BIM files. Accordingly, FIG. 3 shows that MIM system 60 creates at step 62 a MIM inventory 42 based on BIM files 22. However, some elements that do not originate from the BIM files may also manually be added to the MIM database 200. For example, some materials, such as fire extinguishers, may be specified in contractual provisions and may not be included in BIM files at any level of detail or design completion. For this reason, MIM system 60 includes a computer system and software that initially generates each MIM inventory from an input of the then-current BIM files, but allows the contractor to edit and actively maintain MIM database 200 so that an up-to-date, accurate, and complete element inventory is produced for each new BIM revision.

An important aspect of the MIM inventory generating process relies on unique identifiers in the BIM files. Each element type created by BIM system 5 is identified by a unique specification I.D., which is written by MIM system 60 to field 206 in step 62. Similarly, each instance of an element created by BIM system 5 is identified by a unique element instance I.D., which is also written by MIM system 60 to field 208 in step 62. Such unique indicia are typically not encountered by the draftsman during the ordinary course of using the BIM software but are accessible to a programmer through an application programming interface (“API”). Also at step 62, other BIM element attributes are written to fields 208 by MIM system 60 as appropriate. Such attributes may include coordinates, vectors or other drawing and modeling attributes that may be either common to all elements of a given element type or specific to a given instance of an element.

As illustrated by step 64 in FIG. 3, MIM system 60 performs a machine comparison between two element inventories—the current revision (n) 42 and the previous version (n−1) 40. Because element types and element instances that have not been changed maintain the same unique identifiers in each BIM file revision, use of BIM unique identifiers in the model element inventory simplifies the identification of those element types or instances that have been added, changed, or deleted from one version to the next. The changed data 50, which is detected by MIM system 60 at step 64 is made available to the contractor and is used in a quantitative analysis step 66 to rapidly provide an understanding of any implications that arise due to the changes in the new BIM files 22.

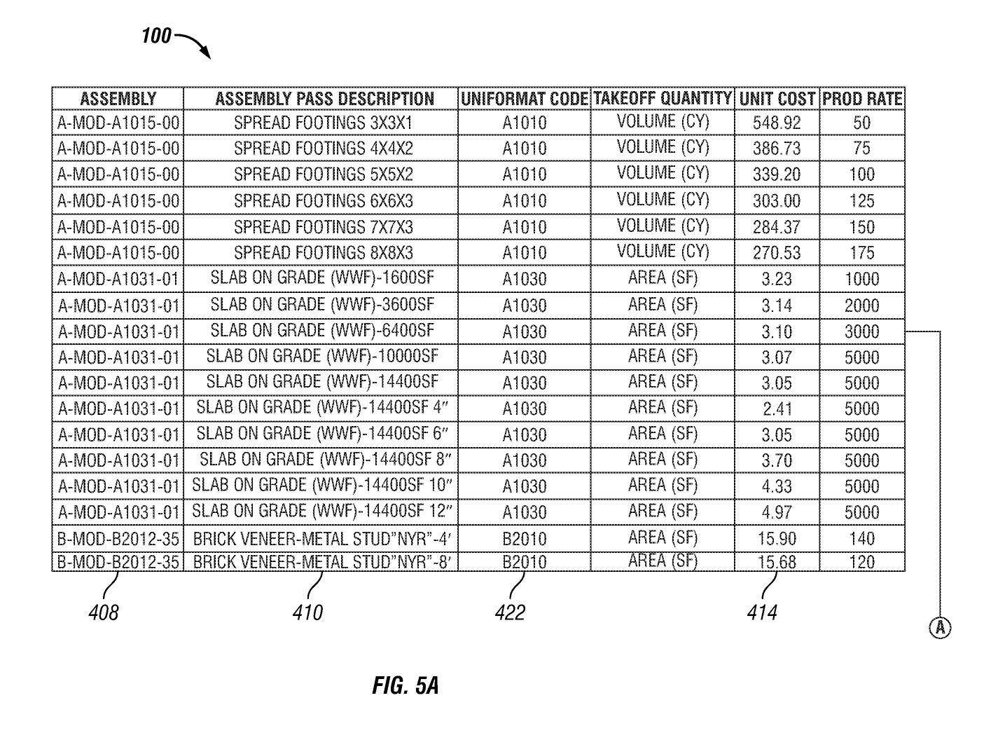

FIG. 4 is a flow chart diagram that details the quantitative analysis step 66 of the process 10 described by FIG. 3. According to the preferred embodiment of the invention, the first step in the quantitative analysis process 66 is to assign, based on the element specification I.D. field 206, various MIM properties to the added or changed element types in the model inventory and to record these properties in database 200. These MIM properties are not part of the native BIM data.

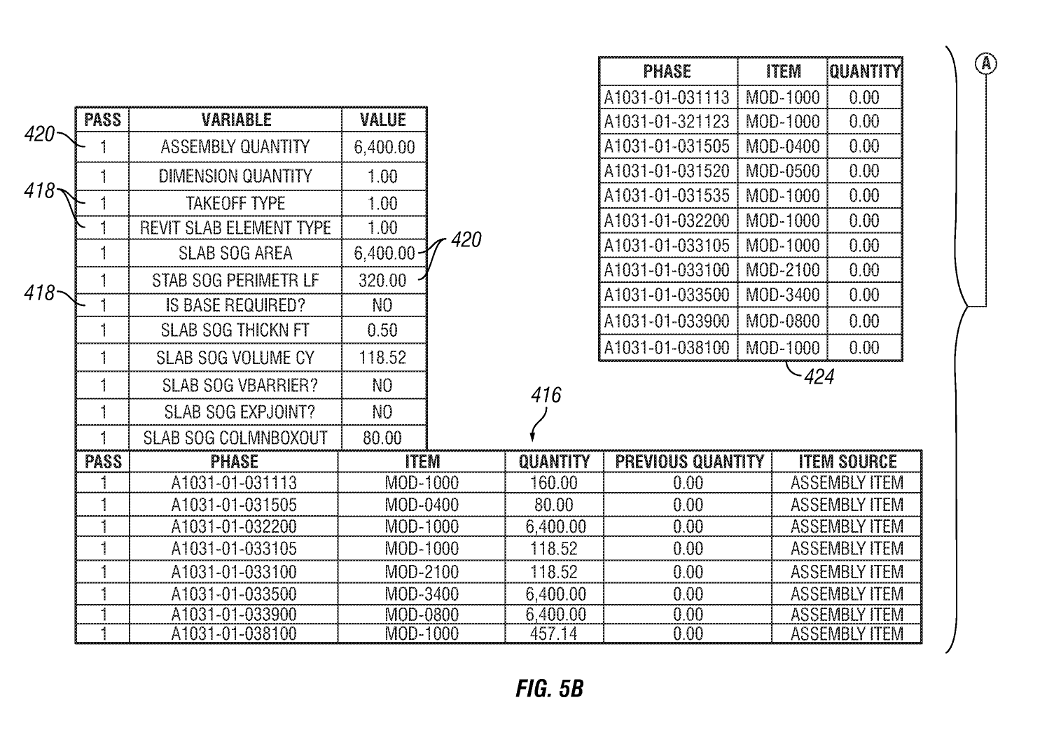

A first of these MIM element properties that is assigned to an element type is an associated assembly pass 410. (See FIG. 5.) In prior art quantity surveying and estimating software, an assembly defines a group of items and includes a set of costing rules and formulas that allow an estimator to more efficiently cost a project. For example, assembly formulas may calculate areas or volumes based on length, width and height data. Typically, an assembly includes related items that are required to complete a particular unit of work. An assembly may be relatively complex and include numerous specification variables to allow a single assembly to handle multiple construction scenarios. In prior art estimating software, these specification variable values are specified by the user when the quantity survey software is run. The specific dimensions (e.g., length, width and height) for a particular assembly in a building plan are taken from the BIM files that document the project design during program run-time. Once an assembly is executed by the estimating software, typically only the material quantity and cost for the assembly are outputted. The specification values, dimensions and unit costs are not provided in the output.

Referring to FIG. 5, according to the preferred embodiment of the invention, an assembly pass 410 is an assembly 408 that has been executed such that its resultant cost 414, quantity survey data 416, the original assembly ruleset, the defined collection of items 424, the specification variable values 418, and the dimensional variable values 420 are all stored as element properties. As indicated by the managed assembly passes database 100, MIM system 60 includes a large number of assembly passes with variations in both physical dimensions (which reflect economies of scale for assemblies with larger geometries) and variations in the assembly specification rules. Referring back to FIG. 4, at step 102, the closest and most appropriate assembly pass 410 from the assembly pass database 100 is assigned to each new or changed element type as an element property in field 210 in MIM database 200 (FIG. 2).

By assigning an assembly pass 410 to each record 201 in the MIM database 200, it is not necessary to re-answer all of the specification variables 418 at run time for subsequent estimates and quantity surveys. This feature allows automated assembly use instead of manual and tedious variable entry at project estimating software runtime. Moreover, this method allows experienced estimators to store and organize their experience and competency in such a way that their knowledge can be used by less experienced estimators who are not competent to answer the original questions posed by the more complex assemblies 408.

Perhaps more importantly, system level summary costs produced by an assembly pass do not exist in an ordinary assembly definition. In prior art systems, an accurate assessment of summary cost is only produced by performing a full, complex and time-consuming estimate using estimating software. However, the prior art process of creating an estimate from BIM files does not relate the resulting summary level costs to unit costs for the BIM elements that comprise the assembly. But, by pre-executing assemblies 408 to derive families of assembly passes 410, and by associating these assembly passes 410 to various element types in the MIM database 200, unit costs 414 are derived at a commodity level of detail. These unit costs 414, which are stored in field 214 of database 200 (FIG. 2), are sensitive to both economy of scale and variations in the construction specification. Alternatively, historical job cost data, which may be present in a separate database, may be used to populate data in unit cost field 214. As a result, the contractor is provided with a valuable tool that has model data with accurate unit price detail, which enables the contractor to actively manage the model inventory, rather than to merely react to changes, and to effect the design process directly and rapidly.

In another embodiment of the invention, rather than assigning an executed assembly pass 410 to each record 201. MIM system 60 may assign an unexecuted assembly 408, along with default specification variable values 418, to each record 201.

Referring to FIG. 4, also at step 102, work breakdown structure (“WBS”) data values are assigned at field 212 (FIG. 2) to newly added or changed MIM inventory element types. WBS data are classifications based on building systems such as plumbing, electrical, HVAC, et cetera. Because the building design process tends to occur in terms of building systems, WBS data may be more useful in managing a design process than data pertaining to job cost accounting and materials quantities. A WBS code may be manually assigned, but ideally it is assigned using a lookup operation from a WBS database 110 based on a Uniformat code, which is preferably defined by the assembly pass 210 that was assigned at previous step 102. The Uniformat code is an industry standard format promulgated by the Construction Specifications Institute. Moreover, via the Uniformat code, MIM system 60 creates an audit trail that allows the user to track element data throughout the entire design process life cycle.

Although FIG. 4 illustrates that assignment passes, WBS codes, and other MIM properties are assigned to records 201 using n−1/n change data 50, default MIM properties may also be automatically assigned at step 62 (FIG. 3) during inventory creation.

After all of the newly added or changed element types have been assigned appropriate MIM properties, at step 104, newly added or changed individual instances of elements are updated. MIM system 60 automatically updates all MIM attributes for each newly added or changed element instance based on its element type as indicated in BIM Element Specification I.D. field 206, populating the MIM attribute fields with the same values stored in these fields for the associated record 201 in Element Type table 220.

However, a more appropriate MIM attribute may exist for a given element instance than that of the default element type, and therefore the operator may wish to manually change the default assignment. Accordingly, any MIM attribute of any model inventory element instance can be modified by the operator at any time. Once a MIM attribute of an instance is manually set, it need not be reset for future BIM revisions, because MIN system 60 will not flag that instance as newly added or changed.

MIM system 60 ideally includes the capability to display inventory data in tabular fashion, arranged, filtered and/or sorted in any number of ways to benefit the operator. By using the native BIM Element Instance I.D. stored in field 208, MIM system 60 also preferably includes the capability to query a Navisworks™ (by Autodesk) 3D model or the like to select particular elements to be displayed graphically. The operator can then visually see the selected model inventory element(s). This capability may be of particular benefit in choosing a more appropriate assembly pass (or other MIM parameter) if desired. For example, an instance of an interior door element type may be specified for exterior use. Graphical display allows such errors to be more readily identified.

The quantitative analysis step 66 preferably includes several types of analysis at various levels of complexity, any one or more of which can be selected by the user. The most rapid (and therefore, perhaps the most useful) analysis is a cost engineering analysis 120. At step 120, the current period earned-value variance data is calculated, the percentage of the scope of work complete and projected balance to complete is assessed, and cost engineering performance metrics are calculated as is known in the art. For example, for each assembly, values for program quantity, budgeted system cost, baseline scheduled and design percentages complete, designed system cost, budgeted cost of work performed, budgeted cost of work scheduled, actual cost of work performed, cost performance index, cost variance, schedule performance index, and schedule variance are calculated and analyzed. Such values may be output to a spreadsheet report.

At step 130, a more comprehensive analysis is performed, in which either a complete model inventory estimate or a complete assembly level estimate is performed. The process of completing the estimate includes migrating model inventory data, including executed assembly pass data, into a separate estimate. At this point, design content not intended to be modeled or not yet completely modeled must be accommodated in the complete estimate. A complete estimate also includes costs of general requirements for the project, fees, permits, and other costs not inherent to the design itself. Such estimates may be calculated more rapidly than in prior art systems, because complete assembly passes, rather than unexecuted assemblies, are stored in the MIM element inventory database 42.

At step 140, another comprehensive analysis is performed using the MIM element inventory 42: A complete 3D graphical construction simulation, including scheduling analysis, is performed, with the use of Autodesk's Navisworks™ simulation software, for example.

Regardless of which analysis step 120, 130 or 140 is performed, at step 150, the contractor uses the results of the analysis for creating project scope feedback 32. The architect uses feedback 32 in the process of creating the next revision of the BIM model, as illustrated in FIG. 3 and described above.

Although the design review cycle 10 is described herein as providing project scope feedback 32 after a quantitative analysis 66, it is also possible to provide a more direct feedback. In one embodiment, two-way communication between MIM system 60 and BIM system 5 may be used, for example, to directly update or change BIM data. For example, if the contractor modifies properties of an element type such as a Uniformat code, this change can be pushed by MIM system 60 to BIM system 5 in order to directly update the BIM architectural model.

FIG. 6 illustrates a more detailed and complete schema for implementing MIM system 60 according to a preferred embodiment of the invention. A Model Inventory Element table 600 is the primary table used in the creation of a model inventory in step 62 (FIG. 3). Table 600 contains all the necessary information to identify from which tables element types and instances are to be extracted, as well as which default MIM data are to be associated with new element types.

Several metadata tables are primarily used to list all possible values for a given work breakdown structure. These metadata tables include a Model Inventory Quantity table 602, which stores all possible take-off quantity values and associated units of measure, a Model Inventory Unit of Measure table 602, which stores all possible take-off unit values, a Model Inventory Uniformat table 606, which stores all possible Uniformat values, a Model Inventory Uniformat Usage table 607, and finally, a Model Inventory Schedule table 608, which stores all possible schedule values.

Two tables associate context to the work breakdown structure tables, indicating which WBS codes can be used for a given model inventory element. These tables include a Model Inventory Element Quantity table 610, which limits the scope of the take-off quantities for a given element, and a Model Inventory Uniformat Usage table 612, which limits the scope of the Uniformat usage for a given element.

Several tables are used to manage the various model inventory revisions stored within database 200. A first of these tables is a Model Inventory table 620, which contains all model inventory revisions and provides a unique ID 203 and metadata for each revision. It is this unique ID 203 that allows for variance comparison between model inventory revisions. Additionally, a Model Inventory Project Tag table 622 contains all tags created for a particular model inventory project, and a Model Inventory Tag table 624 associates available tags with the various model inventory revisions. These tags allow for aggregation of multiple model inventory revisions. For example, a user can aggregate types or instances for all fifty-percent-complete revisions (i.e., architectural, structural, etc.).

Finally, two tables maintain information for all types and instances for the various model Inventory revisions. The first is a Model Inventory Type table 630 that includes a unique composite I.D. for each type within a revision and all the WBS fields for the given type. The second is a Model Inventory Instance table 632 that includes a unique composite I.D. for each instance within a revision and all property values for the instance (e.g., level, geometry, etc.).

The Abstract of the disclosure is written solely for providing the United States Patent and Trademark Office and the public at large with a way by which to determine quickly from a cursory reading the nature and gist of the technical disclosure, and it represents solely a preferred embodiment and is not indicative of the nature of the invention as a whole.

While some embodiments of the invention have been illustrated in detail, the invention is not limited to the embodiments shown; modifications and adaptations of the above embodiment may occur to those skilled in the art. Such modifications and adaptations are in the spirit and scope of the invention as set forth herein:

1. A system (60) for managing a building model inventory comprising:
a computer (8);
first and second record sets (40, 42) each including a plurality of records (201) and a plurality of fields (202) structured for storing elements from first and second building information modeling datasets (20, 22), respectively,
a first software routine (64) stored in a memory of said computer (8) and in communication with said first and second record sets (40, 42), said first software routine designed and arranged to cause said computer (8) to compare said plurality of records (201) of said second record set (42) to said plurality of records (201) of said first record set (40) and identify differences (50); and
a second software routine (120) stored in said memory of said computer (8) and designed and arranged to cause said computer (8) to perform an engineering cost analysis based on said differences (50) identified by said first software routine (64).

2. The system (60) of claim 1 further comprising:
a third software routine (62) stored in said memory of said computer (8) and designed and arranged to create said second record set (42) from said second building information modeling dataset (22).

3. The system (60) of claim 2 wherein:
said second record set (42) includes a unique instance identification field (209); and
said third software routine (62) associates said unique instance identification field (209) for said plurality of records (201) with unique identifiers from said second building information modeling dataset (22).

4. The system (60) of claim 1 further comprising:
a work breakdown structure code field (212) defined in said second record set (42); and
a third software routine (104) stored in said memory of said computer (8) and designed and arranged to cause said computer (8) to store a work breakdown structure code for a first of said plurality of records.

5. The system (60) of claim 1 further comprising:
a plurality of assembly passes (410), each assembly pass (410) defining a predetermined collection of building components (424), rules for calculating the quantity and cost of said collection of building components based on a particular set of dimensions (420) and specifications (418), and resultant cost and quantity figures (414, 416) for said collection of building components, said plurality of assembly passes (410) being stored in an assembly pass database (100);
an assembly pass field (210) defined in said second record set (42); and
a third software routine (102) stored in said memory of said computer (8) and designed and arranged to cause said computer (8) to associate a first of said plurality of assembly passes (410) with said assembly pass field (210) for a first of said plurality of records (201).

6. The system (60) of claim 5 further comprising:
a category code (422) defined by said first of said plurality of assembly passes (410);
a plurality of work breakdown structure codes stored in a work breakdown structure database (110);
a work breakdown structure code field (212) defined in said second record set (42); and
a fourth software routine (104) stored in said memory of said computer (8) and designed and arranged to cause said computer (8) to determine the category code (422) defined by said first of said plurality of assembly passes, to relate said determined category code to a first of said plurality of work breakdown structure codes, and to associate said first of said plurality of work breakdown structure codes with said work breakdown structure code field (212) for said first of said plurality of records (201).

7. The system (60) of claim 6 wherein:
the work breakdown structure codes categorizes according to building systems.

8. The system (60) of claim 5 wherein:
said category code (422) is a standardized Uniformat code.

9. The system (60) of claim 5 wherein:
said second record set (42) includes a unit cost field (214); and
a unit cost is associated with said unit cost field (214) for a first of said plurality of records (201) based on the resultant cost figure (414) of said assembly pass (410) that is associated with assembly pass field (210) for said first of said plurality of records (201).

10. The system (60) of claim 5 wherein:
said second record set (42) includes a unit cost field (214); and
a unit cost is associated with said unit cost field (214) for a first of said plurality of records (201) based on historical cost figures.

11. The system (60) of claim 1 wherein:
said second record set (42) includes an element type field (206) for uniquely identifying data defining a first element type and an element instance field (208) for uniquely identifying data defining a first specific instance of said first element type.

12. The system (60) of claim 1 further comprising:
an inventory database (200) structured for storing said first and second record sets (40, 42), said inventory database (200) including a first table (220) structured for storing first data defining an element type and a second table (230) structured for storing second data defining an instance of said element type.

13. A method (10) for managing a building model element inventory comprising the steps of:
importing a first version of a building information model (20) into an inventory database (200);
importing a second version of said building information model (22) into said inventory database (200);
creating a first inventory record set (40) from said inventory database (200) that represents said first version of said building information model (20);
creating a second inventory record set (42) from said inventory database (200) that represents said second version of said building information model (22);
comparing said second record set (42) to said first record set (40) by a computer (8) to identify added, modified and deleted element data (50); and
performing a quantitative analysis (66) of said added, modified and deleted element data (50).

14. The method (10) of claim 13 wherein:
the step of performing a quantitative analysis (66) includes a step (120) of calculating a value selected from the group consisting of an earned-value variance, a designed system cost, a budgeted system cost, a budget cost of work performed, a budgeted cost of work scheduled, an actual cost of work performed, a cost performance index, a cost variance of a schedule performance index, and a schedule variance.

15. The method (10) of claim 13 further comprising the step of:
storing in said inventory database (200) model inventory parameter data selected from a group consisting of an assembly pass field (210), a work breakdown structure field (212), and a unit cost field (214).

16. The method (10) of claim 13 further comprising the step of:
storing in said inventory database (200) first data defining a first element type and second data defining a first specific instance of said first element type.
